(19) United States
(12) Patent Application Publication
(10) Pub. No.: US 2005/0174443 A1
(43) Pub. Date: Aug. 11, 2005

(54) Image sensing apparatus and method of controlling same

(76) Inventors: Ikuo Niimura, Tokyo (JP); Kenji Miwa, Kanagawa-ken (JP)

Correspondence Address: MORGAN & FINNEGAN, L.L.P., 3 WORLD FINANCIAL CENTER, NEW YORK, NY, 10281-2101, US

(21) Appl. No.: 11/053,435

(22) Filed: Feb. 8, 2005

(30) Foreign Application Priority Data
Feb. 9, 2004 (JP) 2004-032736
Jun. 14, 2004 (JP) 2004-175999
Jan. 26, 2005 (JP) 2005-018255

(51) Int. Cl. H04N 5/76

(52) U.S. Cl. 348/231.2

(57) ABSTRACT

An image sensing apparatus has a calculating unit adapted to calculate number of images that can be captured when image data representing captured images is recorded on first and second recording media. The calculating unit calculates number of images that can be captured in accordance with available capacity of the first recording medium and shooting conditions in a case where available capacity of the first recording medium is less than available capacity of the second recording medium, and calculates number of images that can be captured in accordance with available capacity of the second recording medium and shooting conditions in a case where available capacity of the second recording medium is less than available capacity of the first recording medium.

### FIELD OF THE INVENTION

This invention relates to an image sensing apparatus (such as a digital camera, digital video camera and mobile telephone equipped with a camera) in which multiple recording media can be mounted and to a control method thereof.

### BACKGROUND OF THE INVENTION

Image sensing apparatuses using image sensors such as CCDs and CMOS sensors have become widely available owing to advances in semiconductor technology, and these can now be incorporated in mobile telephones and mobile information terminals (PDAs).

In such an image sensing apparatus, a recording medium incorporating a semiconductor memory or small size magnetic disk, etc., is currently the most widely used for recording sensed images. Such recording media include one which is built in the image sensing apparatus and one which is detachably mounted on or inserted into a slot provided in the image sensing apparatus. Generally, depending upon the image sensing apparatus, either one of these media or both of these media are used. Image sensing apparatuses that have a plurality of slots for mounting recording media also exist.

An image sensing apparatus normally records image data by a recording format from among a plurality of recording formats that the user can select. Image size, compression scheme (selection of non-compression or compression, selection from a plurality of compression schemes, etc.) and compression rate, etc., are examples of such selectable formats.

Further, an image sensing apparatus capable of recording on multiple recording media known in the art includes one that has a backup function by recording the same image on multiple recording media by means of a single image sensing operation [see the specification of Japanese Patent Application Laid-Open No. 7-231420 (U.S. Pat. No. 5,640,203)].

In case of a digital camera having a recording mode for recording image data representing a captured image on multiple recording media, it desired that the camera be so adapted that when this recording mode is active, the user can be notified accurately of how many more times images can be captured. Such user preference is not limited to digital cameras and arises also with regard to image sensing apparatuses such as digital video cameras and mobile telephones equipped with a camera. It should be noted that the term “image sensing apparatus” refers to an apparatus having a function for shooting an image (moving or still) and generating image data representative thereof.

Further, the available capacities of multiple recording media inserted into the slots of an image sensing apparatus having a backup function are not necessarily the same. There are instances where recording media the overall capacities of which differ are inserted. For example, a 1 GB recording medium may be inserted into a first slot and a 512 MB recording medium may be inserted into a second slot. Further, even if the available capacities are identical at the start, a difference in the available capacities will arise if, say, the set-up is such that uncompressed image data is recorded on one medium and compressed image data on another. In addition, if shooting with a setting that does not perform backup is mixed with shooting with a setting that does, a disparity in available capacity will arise between recording media.

As a consequence of the above, there is the possibility that a recording medium designated for backup purposes will run out even though the recording medium used ordinarily for recording is still capable of recording. Backup in such case can no longer be achieved. In particular, if shooting is performed immediately after the camera is started up, a recording medium may have been replaced since the last time photography was performed and there is the likelihood that the user will realize that the available capacity of the backup recording medium is inadequate only when the user attempts to shoot.

### SUMMARY OF THE INVENTION

Accordingly, an object of the present invention is to improve the operability of a backup recording mode (a recording mode in which image data representing a captured image is recorded on multiple recording media).

According to an aspect of the present invention, there is provided an image sensing apparatus comprising: a calculating unit adapted to calculate number of images that can be captured when image data representing captured images is recorded on first and second recording media, wherein the calculating unit calculates number of images that can be captured in accordance with available capacity of the first recording medium in a case where available capacity of the first recording medium is less than available capacity of the second recording medium, and wherein the calculating unit calculates number of images that can be captured in accordance with available capacity of the second recording medium in a case where available capacity of the second recording medium is less than available capacity of the first recording medium.

According to another aspect of the present invention, there is provided a control method of an image sensing apparatus for calculating number of images that can be captured when image data representing captured images is recorded on first and second recording media, comprising: a first calculating step of calculating number of images that can be captured in accordance with available capacity of the first recording medium in a case where available capacity of the first recording medium is less than available capacity of the second recording medium, and a second calculating step of calculating number of images that can be captured in accordance with available capacity of the second recording medium in a case where available capacity of the second recording medium is less than available capacity of the first recording medium.

Other objects and advantages besides those discussed above shall be apparent to those skilled in the art from the description of a preferred embodiment of the invention which follows. In the description, reference is made to accompanying drawings, which form a part thereof, and will illustrate an example of the various embodiments of the invention. Such example, however, is not exhaustive of the various embodiments of the invention, and therefore reference is made to the claims which follow the description for determining the scope of the invention.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram illustrating the main components of an image sensing apparatus according to first and second embodiments of the present invention;

FIG. 2 is a flowchart for describing processing executed by the image sensing apparatus according to the first embodiment;

FIG. 3 is a flowchart for describing processing executed by the image sensing apparatus according to the second embodiment;

FIG. 4 is a block diagram illustrating an example of the structure of a digital still camera serving as an image sensing apparatus according to third to fifth embodiments of the present invention;

FIG. 5 is a flowchart for describing processing according to the third embodiment;

FIG. 6 is a flowchart for describing processing according to the fourth embodiment; and

FIG. 7 is a flowchart for describing processing according to the fifth embodiment.

### DETAILED DESCRIPTION OF THE PREFERRED EMBODIMENTS

Preferred embodiments of the present invention will now be described with reference to the drawings. In each of the embodiments that follow, an apparatus (e.g., a digital camera, digital video camera, mobile telephone equipped with a camera, etc.) having a function for shooting an image (moving or still) and generating image data representative thereof shall be referred to as an “image sensing apparatus”.

### First Embodiment

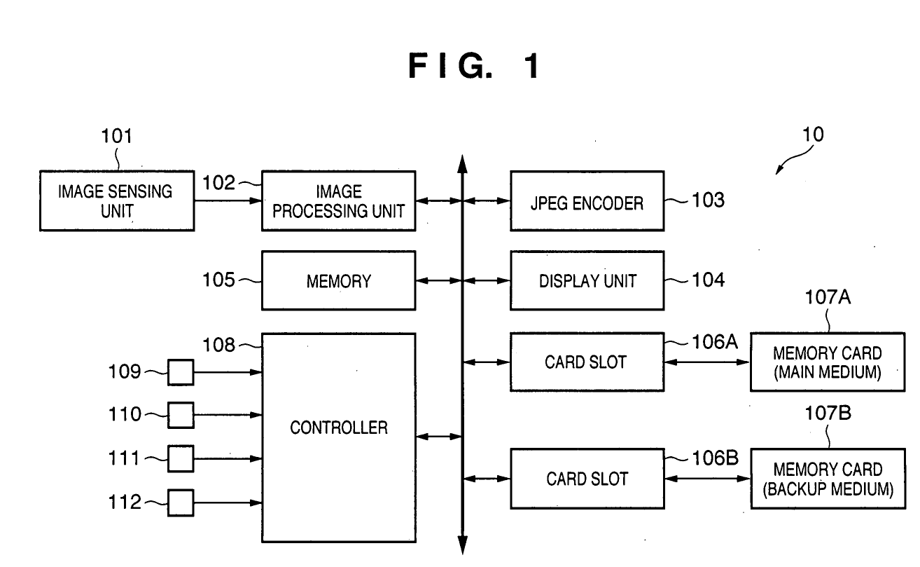

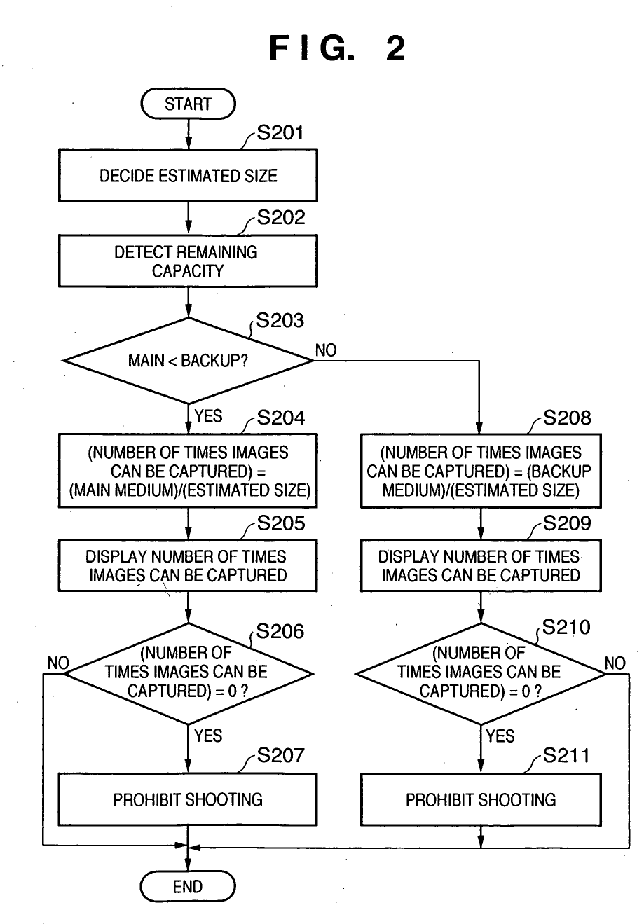

A first embodiment will be described with reference to FIGS. 1 and 2.

FIG. 1 is a block diagram illustrating the main components of an image sensing apparatus 10. The latter is capable of mounting two recording media. The user can set one of these two recording media as a main medium and the other as a backup medium. The image sensing apparatus 10 has a normal recording mode and a backup recording mode. The normal recording mode is for recording image data of a captured image only on the main medium. The backup recording mode is for recording image data of a captured image on both the main medium and the backup medium.

In FIG. 1, an image sensing unit 101 captures an image using an image sensor (a CCD sensor or CMOS sensor, etc.) and generates image data representing the captured image. An image processing unit 102 applies prescribed image processing to the image data generated by the image sensing unit 101. A JPEG encoder 103 compresses image data, which is held in a memory 105, by the JPEG scheme and generates an image file that contains the image data compressed by the JPEG scheme.

A display unit 104 displays a thumbnail image of a captured image, a menu screen and number of times images can be captured on an LCD (liquid crystal display device). The memory 105 holds the maximum data size of image data estimated for every shooting condition (resolution, compression mode, etc.). The estimated maximum data size of image data for every prescribed shooting condition (resolution, compression mode, etc.) shall be referred to as the “estimated size”.

A memory card 107A is one example of a recording medium that can be mounted on a first card slot 106A. FIG. 1 illustrates an example in which the memory card 107A has been set as the main medium. A memory card 107B is one example of a recording medium that can be mounted on a second card slot 106B. FIG. 1 illustrates an example in which the memory card 107B has been set as the backup medium. A controller 108 controls the operation of the image sensing apparatus 10.

A release switch 109 is for instructing shooting. A main/backup medium setting unit 110 sets the memory card 107A or 107B as the main or backup medium. A shooting condition setting unit 111 is for setting shooting conditions (resolution, compression mode, etc.). Available resolutions are HIGH, MEDIUM, which is a lower resolution than HIGH, and LOW, which is a lower resolution than MEDIUM. Available compression rates are FINE and NORMAL, which is a higher compression rate than FINE. The maximum data size of image data of a captured image differs depending upon the shooting conditions. Maximum data size of image data estimated for every shooting condition is held in the memory 105. A recording mode changeover unit 112 is for activating the normal recording mode or the backup recording mode. With the image sensing apparatus 10 of FIG. 1, it is assumed that the backup recording mode is deactivated if the normal recording mode has been activated, and that the normal recording mode is deactivated if the backup recording mode has been activated.

FIG. 2 is a flowchart for describing processing executed in the image sensing apparatus 10. The processing illustrated in FIG. 2 is executed when the normal recording mode is changed to the backup recording mode. This processing is executed also when photography is performed in the backup recording mode.

First, in step S201, the controller 108 decides the estimated size that corresponds to the present shooting conditions (resolution, compression mode, etc.) and reads the estimated size decided out of the memory 105. In this embodiment, the estimated size corresponding to the shooting conditions is recorded in the memory 105. However, it is also possible to calculate the estimated size by a prescribed calculation formula whenever an image is captured.

In step S202, the controller 108 detects the remaining capacities of the memory cards 107A and 107B.

In step S203, the controller 108 compares the remaining capacities of the memory cards 107A and 107B and determines whether the remaining capacity of the memory card 107B is greater than that of the memory card 107A. In other words, the controller 108 determines whether the remaining capacity of the backup medium is greater than that of the main medium. If the remaining capacity of the backup medium is greater than that of the main medium, control proceeds to step S204; otherwise, control proceeds to step S208.

In step S204, the controller 108 divides the remaining capacity of the memory card 107A, which is the main medium, by the estimated size, thereby calculating the number of times images can be captured. More specifically, controller 108 calculates the number of images that can be captured using the remaining capacity of the main medium, which in this case is less than that of the backup medium. If the remaining capacity of the memory card 107A is not greater than the estimated size, then the number of times images can be captured is to be zero.

In step S205, the display unit 104 displays the number of times images can be captured calculated in step S204. As a result, the user can ascertain how many more images can be recorded in the backup recording mode using both the main and backup media.

In step S206, the controller 108 determines whether the number of times images can be captured is zero. Control proceeds to step S207 if the number is zero.

In step S207 the controller 108 prohibits shooting in the backup recording mode. The display unit 104 displays a message or image indicating that shooting in the backup recording mode has been prohibited. The display unit 104 further displays a message or image indicating that the memory card 107A is full. In this case, if the user changes the mode from the backup recording mode to the normal recording mode and changes the memory card 107B from the backup medium to the main medium, photography in the normal recording mode will become possible until the memory card 107B becomes full.

Even if the recording mode has been changed to the normal recording mode and, moreover, the memory card 107B has been changed to the main medium in accordance with a command from the user, the controller 108 calculates the number of times images can be captured be captured using the estimated size that has been decided in dependence upon the shooting conditions and the remaining capacity of the memory card 107B and causes the calculated number to be displayed on the display unit 104. Whenever an image is captured in the normal recording mode, the controller 108 calculates the number of times images can be captured and causes this number to be displayed on the display unit 104. When the calculated number of times becomes zero, the controller 108 prohibits shooting in the normal recording mode and causes the display unit 104 to display a message or image indicating that shooting in the normal recording mode has been prohibited.

In step S208, on the other hand, the controller 108 divides the remaining capacity of the memory card 107B, which is the backup medium, by the estimated size, thereby calculating the number of times images can be captured. More specifically, controller 108 calculates the number of images that can be captured using the remaining capacity of the backup medium, which in this case is less than that of the main medium. If the remaining capacity of the memory card 107B is not greater than the estimated size, then the number of times images can be captured is to be zero.

In step S209, the display unit 104 displays the number of times images can be captured calculated in step S208. As a result, the user can ascertain how many more images can be recorded using both the main and backup media.

In step S210, the controller 108 determines whether the number of times images can be captured is zero. Control proceeds to step S211 if the number is zero.

In step S211, the controller 108 prohibits shooting in the backup recording mode. The display unit 104 displays a message or image indicating that shooting in the backup recording mode has been prohibited. The display unit 104 further displays a message or image indicating that the memory card 107B is full. In this case, if the user changes the mode from the backup recording mode to the normal recording mode, photography in the normal recording mode will become possible until the memory card 107A, which is the main medium, becomes full.

Even if the recording mode is changed to the normal recording mode in accordance with a command from the user, the controller 108 calculates the number of times images captured be captured using the estimated size that has been decided in dependence upon the shooting conditions and the remaining capacity of the memory card 107A and causes the calculated number to be displayed on the display unit 104. Whenever an image is captured in the normal recording mode, the controller 108 calculates the number of times images can be captured and causes this number to be displayed on the display unit 104. When the calculated number of times becomes zero, the controller 108 prohibits shooting in the normal recording mode and causes the display unit 104 to display a message or image indicating that shooting in the normal recording mode has been prohibited.

Thus, in accordance with the image sensing apparatus 10 according to the first embodiment, the number of times images can be captured is calculated based upon whichever of the recording media has the smallest remaining capacity when the backup recording mode is in effect. As a result, the user can be notified reliably of how many images can be recorded in the backup recording mode using both the main medium 107A and the backup medium 107B.

### Second Embodiment

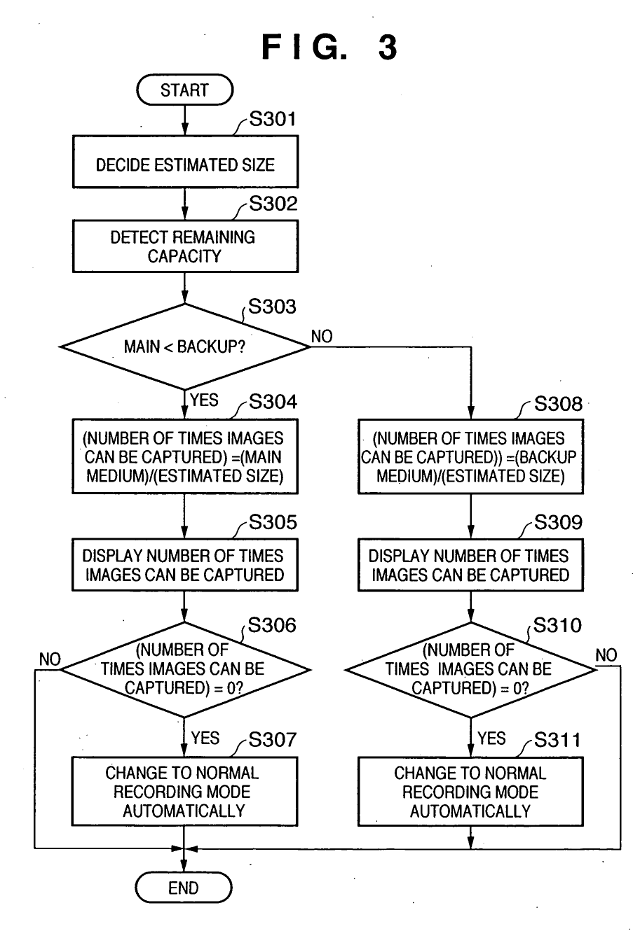

A second embodiment of the present invention will now be described with reference to FIGS. 1 and 3.

FIG. 3 is a flowchart describing processing executed in the image sensing apparatus 10. The processing illustrated in FIG. 3 is executed when the normal recording mode is changed to the backup recording mode. This processing is executed also when photography is performed in the backup recording mode.

First, in step S301, the controller 108 decides the estimated size that corresponds to the present shooting conditions (resolution, compression mode, etc.) and reads the estimated size decided out of the memory 105. In this embodiment, the arrangement adopted is one in which the estimated size corresponding to the shooting conditions is recorded in the memory 105. However, it is also possible to calculate the estimated size by a prescribed calculation formula whenever an image is captured.

In step S302, the controller 108 detects the remaining capacities of the memory cards 107A and 107B.

In step S303, the controller 108 compares the remaining capacities of the memory cards 107A and 107B and determines whether the remaining capacity of the memory card 107B is greater than that of the memory card 107A. In other words, the controller 108 determines whether the remaining capacity of the backup medium is greater than that of the main medium. If the remaining capacity of the backup medium is greater than that of the main medium, control proceeds to step S304; otherwise, control proceeds to step S308.

In step S304, the controller 108 divides the remaining capacity of the memory card 107A, which is the main medium, by the estimated size, thereby calculating the number of times images can be captured. More specifically, the controller 108 calculates the number of images that can be captured using the remaining capacity of the main medium, which in this case is less than that of the backup medium. If the remaining capacity of the memory card 107A is not greater than the estimated size, then the number of times images can be captured is zero.

In step S305, the display unit 104 displays the number of times images can be captured calculated in step S304. As a result, the user can ascertain how many more images can be recorded in the backup recording mode using both the main and backup media.

In step S306, the controller 108 determines whether the number of times images can be captured is zero. Control proceeds to step S307 if the number is zero.

In step S307, the controller 108 changes the memory card 107B from the backup medium to the main medium and changes the backup recording mode to the normal recording mode automatically. The display unit 104 displays a message or image indicating that the backup recording mode has been changed automatically to the normal recording mode. The display unit 104 further displays a message or image indicating that memory card 107B has been changed from the backup medium to the main medium. The display unit 104 further displays a message or image indicating that the memory card 107A is full. In this case, the user is capable of shooting in the normal recording mode until the memory card 107B, which is the main medium, becomes full.

Even if the recording mode has been changed automatically to the normal recording mode and, moreover, the memory card 107B has been changed automatically to the main medium, the controller 108 calculates the number of times images can be captured using the estimated size that has been decided in dependence upon the shooting conditions and the remaining capacity of the memory card 107B and causes the calculated number to be displayed on the display unit 104. Whenever an image is captured in the normal recording mode, the controller 108 calculates the number of times images can be captured and causes this number to be displayed on the display unit 104. When the calculated number of times becomes zero, the controller 108 prohibits shooting in the normal recording mode and causes the display unit 104 to display a message or image indicating that shooting in the normal recording mode has been prohibited.

In step S308, on the other hand, the controller 108 divides the remaining capacity of the memory card 107B, which is the backup medium, by the estimated size, thereby calculating the number of times images can be captured. More specifically, the controller 108 calculates the number of images that can be captured using the remaining capacity of the backup medium, which in this case is less than that of the main medium. If the remaining capacity of the memory card 107B is not greater than the estimated size, then the number of times images can be captured is zero.

In step S309, the display unit 104 displays the number of times images can be captured calculated in step S308. As a result, the user can ascertain how many more images can be recorded using both the main and backup media.

In step S310, the controller 108 determines whether the number of times images can be captured is zero. Control proceeds to step S311 if the number is zero.

In step S311, the controller 108 changes the backup recording mode to the normal recording mode automatically. The display unit 104 displays a message or image indicating that the backup recording mode has been changed automatically to the normal recording mode. The display unit 104 further displays a message or image indicating that the memory card 107B is full. In this case, the user is capable of shooting in the normal recording mode until the memory card 107A, which is the main medium, becomes full.

Even if the recording mode has been changed automatically to the normal recording mode, the controller 108 calculates the number of times images can be captured using the estimated size that has been decided in dependence upon the shooting conditions and the remaining capacity of the memory card 107A and causes the calculated number to be displayed on the display unit 104. Whenever an image is captured in the normal recording mode, the controller 108 calculates the number of times images can be captured and causes this number to be displayed on the display unit 104. When the calculated number of times becomes zero, the controller 108 prohibits shooting in the normal recording mode and causes the display unit 104 to display a message or image indicating that shooting in the normal recording mode has been prohibited.

Thus, in accordance with the image sensing apparatus 10 according to the second embodiment, the number of times images can be captured is calculated based upon whichever of the recording media has the smallest remaining capacity when the backup recording mode is in effect. As a result, the user can be notified reliably of how many images can be recorded in the backup recording mode using both the main medium 107A and the backup medium 107B.

Further, in accordance with the image sensing apparatus 10 of the second embodiment, if the main medium becomes full when the backup recording mode is in effect, the backup recording mode is changed automatically to the normal recording mode and the backup medium is changed to the main medium automatically, thereby making it possible to prevent shooting from being inhibited. Further, since it is no longer necessary for the user to change over the recording mode, the risk that the user will lose a photo opportunity can be reduced.

In addition, the image sensing apparatus 10 of the second embodiment is such that if the backup medium is filled to capacity when the backup recording mode is active, the backup recording mode is change to the normal recording mode automatically, thereby making it possible to prevent shooting from being inhibited. Further, since it is no longer necessary for the user to change over the recording mode, the risk that the user will lose a photo opportunity can be reduced.

### Third Embodiment

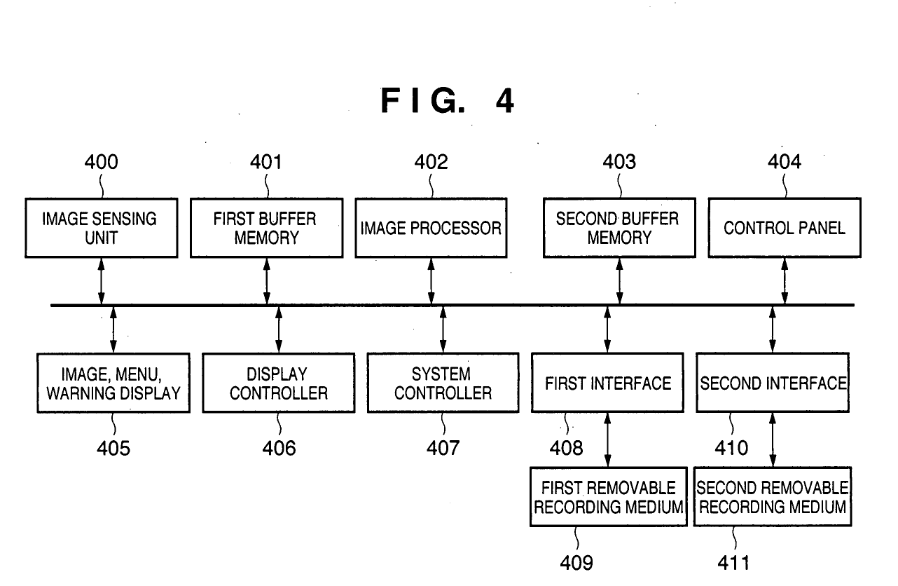

FIG. 4 is a block diagram illustrating an example of the structure of a digital still camera serving as an example of an image sensing apparatus according to a third embodiment of the present invention. In order to facilitate the description and an understanding of the invention, a digital still camera in which multiple removable recording media can be utilized will be described as an image sensing apparatus in the description that follows. However, it goes without saying that, in a manner similar to that of the first and second embodiments, the present invention is applicable to any image sensing apparatus that can record image data on multiple recording media simultaneously. For example, in a computer having a camera built in or connected thereto, the configuration may be such that a sensed image is capable of being recorded on multiple recording media such as a hard disk and memory card.

By way of example, one of the recording media may be a fixed, built-in type, a recording medium itself may of course be a semiconductor memory or small size magnetic disk, or it may be one having the form of a tape or disk. It goes without saying that a video camera having a still image capturing function and a mobile telephone or PDA having a camera function, etc., may also constitute an image sensing apparatus according to the present invention. Further, the recording medium need not necessarily be connected directly to the image sensing apparatus. For example, the image sensing apparatus may be such that it is capable of writing to a recording medium that has been build in or mounted and to a recording medium connected over a network. It should be noted that the term “digital ‘still’ camera” as used in this specification is for the sake of expediency only and is not intended to exclude a function for shooting moving images.

As shown in FIG. 4, a digital still camera according to this embodiment comprises an image sensing unit 400 that includes an optical finder, an image sensing element such as a CCD or CMOS necessary for capturing images, optical members such as lenses and various electronic devices; a first buffer memory 401, which is a pre-buffer that stores captured image data; an image processor 402 for applying prescribed image processing and compression processing to image data that has been stored in the first buffer memory 401; a second buffer memory 403, which is a post-buffer for storing image data that has undergone image processing and compression processing; a control panel 404 comprising buttons, keys and dials, etc., so that the user may operate the digital still camera proper, these operations including shooting and changeover of shutter speed and exposure, etc.; a display unit 405, which is capable of functioning also as a viewfinder, for displaying captured images, displaying menus for the purpose of setting and confirming camera operating parameters, and displaying warnings, etc.; a controller 406 for controlling the display unit 405; a system controller 407 that controls the overall digital still camera; and first and second interfaces (slots) 408 and 410, which are for interfacing semiconductor memory cards the foremost of which is a compact flash® card, and a removable recording medium such as a microdrive. It should be noted that some of the items displayed on the display unit 405 are also displayed within the optical finder.

Further, removable recording media 409 and 411 used upon being mounted on the first and second interfaces 408 and 410, respectively, are also illustrated. Though not illustrated in FIG. 4, the digital still camera may also have communication interfaces such as those that support USB, IEEE 1394 and Bluetooth for connecting the camera to an apparatus such as a personal computer or to a communication network.

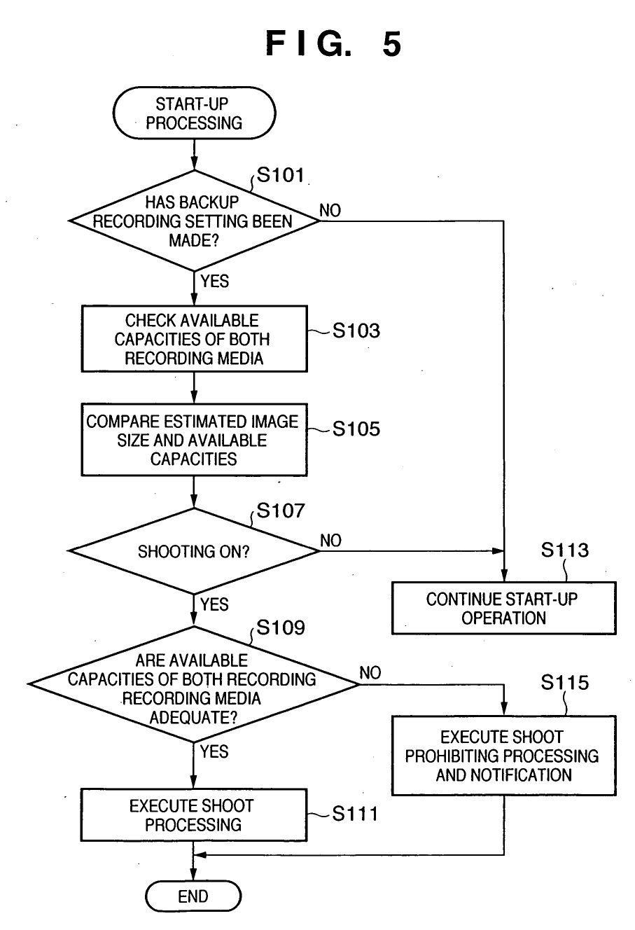

Operation of the camera when it has been set up in backup recording mode will be described with reference to the flowchart of FIG. 5. It should be noted that whether backup recording (namely recording simultaneously on multiple recording media) is to be performed at the time of image capture and the method of recording on each recording medium at the time of backup recording mode have been set up in advance by using the control panel 404 to operate a GUI (Graphical User Interface) such as a menu displayed on the display unit 405. The content of these settings is stored on a non-volatile memory (not shown) internally of the camera. Even when the power supply of the camera is turned off, therefore, a setting as to whether or not backup recording is to be performed and the content of various other settings will be retained within the camera.

It will be assumed here that the first recording medium 409 has been set as the main medium and that the second recording medium 411 has been set as the backup medium. The operation described below is implemented by executing a prescribed program by a CPU, which is possessed by the system controller 407, thereby to control various components.

The digital still camera according to this embodiment is that if it has been set in the backup recording mode, then photography will be allowed only in a case where both the main recording medium and the backup recording medium have recording capacities greater than a predetermined value. That is, if the recording capacity of ether recording medium is less that the predetermined value, then shooting is prohibited. This ensures that backup recording will be performed reliably.

First, when the camera is started up (i.e., when the power supply is turned on), the system controller 407 refers to the non-volatile memory (not shown) and checks to determine whether backup recording mode has been set in step S101. If backup recording mode has not been set, ordinary start-up processing is continued (step S113). If backup recording mode has been set (“YES” in step S101), then the available capacity (recording capacity) of the second recording medium 411 for backup recording (the backup medium) and the available capacity of the first recording medium 409 for normal recording (the main medium) are checked (step S103) irrespective of whether the first and second recording media have been replaced since the last time recording was performed. Next, the system controller 407 determines whether the available capacity is enough for achieving recording the next time an image is captured (step S105). Various methods can be utilized to make this determination. For example, according to one method, this determination can be realized by determining an estimated image data size by using values of settings that effect upon image data size, such as the recording format (compression rate, encoding scheme, etc.), the image size (numbers of pixels horizontally and vertically) and sensitivity (ISO) value and comparing the estimated image data size with the actual available capacity that was determined in step S103. Another method is to compare a previously prepared fixed value with the actual available capacity.

It should be noted that if the setting is such that the image data size for backup and the image data size for normal recording become different owing to recording formats or image sizes, it is preferred that the determination of step S105 to be performed, based on the setting, for the main recording medium and the backup recording medium, respectively.

Next, in step S107, the system controller 407 determines whether a shooting operation is ON or not. Whether or not shooting is ON can be determined by detecting whether the mode that has been set on the control panel 404 is the shooting mode or whether the shutter release button is pressed halfway.

If the shooting operation is found not to be ON in step S107, then control proceeds to step S113, where the start-up operation is continued. If the shooting operation is to be ON in step S107, on the other hand, then the system controller 407 investigates, based upon the result of the comparison performed in step S105, whether the available capacities of both the first (main) recording medium 409 and second (backup) recording medium 411 are adequate for shooting at least one image. If both are adequate, then control proceeds to shoot processing in step S111. Here if the shutter release button is pressed fully, backup recording is performed in accordance with the content of the settings and processing is exited. On the other hand, if the available capacity of either the main recording medium 409 or backup recording medium 411 is less than the predetermined value, control proceeds to step S115, where shooting is prohibited. More specifically, a shooting operation (full depression of the shutter release button, for example) performed at the control panel 404 is invalidated. If shooting is prohibited, this is reported to the user.

The method of presenting this notification to the user is not particularly limited. A notification method employed generally may be adopted. For example, a message display may be presented on the display unit 405, a warning lamp may be lit, an error display may be presented within the optical finder, a beep tone may be issued, or any combination of these may be used. In the event that a prescribed operation is performed at the control panel 404 in response to notification presented by a message display, for example, then system controller 407 terminates processing upon construing that the user has been made aware of the notification.

With regard to the notification given in step S115, it is desired that the reason (inadequate remaining capacity for the recording medium) also be reported to the user and not merely the fact that shooting is prohibited. In such case it would be even more preferable to arrange it so that the user can be made aware of which recording medium has the inadequate available capacity. Further, the actual available capacity and the estimated image data size prevailing at the time of photography (the estimated image data size may be that used in step S103) may be reported to the user together. This will serve to prompt the user to replace a recording medium or to acquire available capacity by deleting unnecessary image data.

By executing processing corresponding to step S103, S105 and S109 again after the detection of an operation that can change the available capacity of a recording medium, such as exchange of the recording medium or processing for deleting data from the recording medium, the prohibition on shooting can be removed automatically at the moment available capacity has been acquired. Alternatively, the prohibition on shooting may be removed at the moment cancellation of the setting for backup recording is detected (it goes without saying that shooting will not be possible in the event that the recording medium for normal recording has already run out of available capacity).

Thus, in accordance with this embodiment, if the situation is such that the camera has been set up for backup recording, shooting is prohibited in a case where both the recording medium for normal recording and the recording medium for backup recording do not have available capacity equivalent to an estimated amount of image data corresponding to one image. Accordingly, reliable backup recording is assured even in a case where backup recording is performed using multiple recording media having different available capacities. In particular, reliable backup recording is possible even in a case where a recording medium may have undergone a change since the last time an image was captured, as when at least one recording medium is removable and an image is captured immediately after start-up.

### Fourth Embodiment

In the third embodiment, shooting of images is prohibited unconditionally in the event that both the main recording medium and the backup recording medium do not have available capacity equivalent to an estimated amount of image data corresponding to one image in a case where the camera has been set up for backup recording. By contrast, according to this embodiment, if the available capacity only of the backup recording medium is inadequate, then backup recording is cancelled temporarily and recording is allowed only on the main recording medium. In order to allow the user to make this setting, it will suffice to provide a check item such as “GIVE PRIORITY TO SHOOTING IF AVAILABLE CAPACITY OF BACKUP RECORDING MEDIUM IS INADEQUATE” as a backup recording setting item.

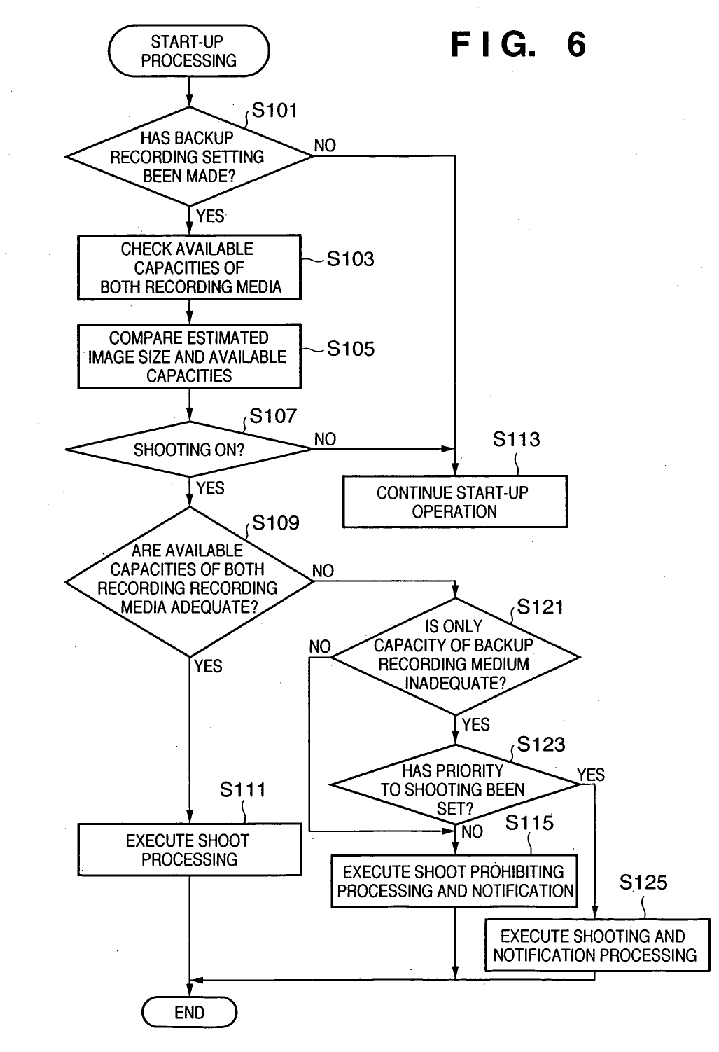

Processing at start-up of the digital still camera according to this embodiment will be described with reference to the flowchart shown in FIG. 6. Steps in FIG. 6 for which the processing is identical with that of FIG. 5 are identified by like step numbers and need not be described again. Further, since the structure of the digital still camera according to this embodiment is identical with that shown in FIG. 4, the components thereof also need not be described again.

The processing of steps S101 to S111 in this embodiment is identical with that of the same-numbered steps of the third embodiment. The processing is different from step S121 onward in FIG. 6, this being processing executed when it has been determined in step S109 that the available capacity of either recording medium is inadequate. In step S121, the system controller 407 checks to determine whether the recording medium for which the available capacity is inadequate is only the recording medium for backup recording. If the available capacity of at least the normal recording medium is inadequate, control proceeds to step S115, where the above described processing for prohibiting shooting and so notifying the user is executed.

On the other hand, if only the available capacity of the backup recording medium is inadequate, control proceeds to step S123. Here the system controller 407 refers to a setting item storage area in the non-volatile memory to determine whether the check item “GIVE PRIORITY TO SHOOTING IF AVAILABLE CAPACITY OF BACKUP RECORDING MEDIUM IS INADEQUATE” has been checked. If this item has been checked, then control proceeds to step S125, where shoot processing is executed. In this case, however, backup recording is not carried out. Accordingly, the user is notified of the fact that backup recording is not being performed because the available capacity of the backup recording medium is inadequate. The method of notifying the user can be implemented in a manner similar to that in which the prohibition on shooting is reported in step S115.

Thus, this embodiment provides effects in addition to those of the third embodiment. Specifically, in the event that only the available capacity of the backup recording medium is inadequate, the user is allowed to set whether priority should be given to shooting. As a result, even in a case where backup recording is performed using multiple recording media for which the available capacities differ, backup recording is possible in reliable fashion and, moreover, it is possible to shoot images in a case where only the available capacity of the backup recording medium is inadequate.

### Fifth Embodiment

In the above embodiments, start-up processing or processing executed at the start of shoot processing in the start-up state has been described. This embodiment, however, relates to processing when shooting ends.

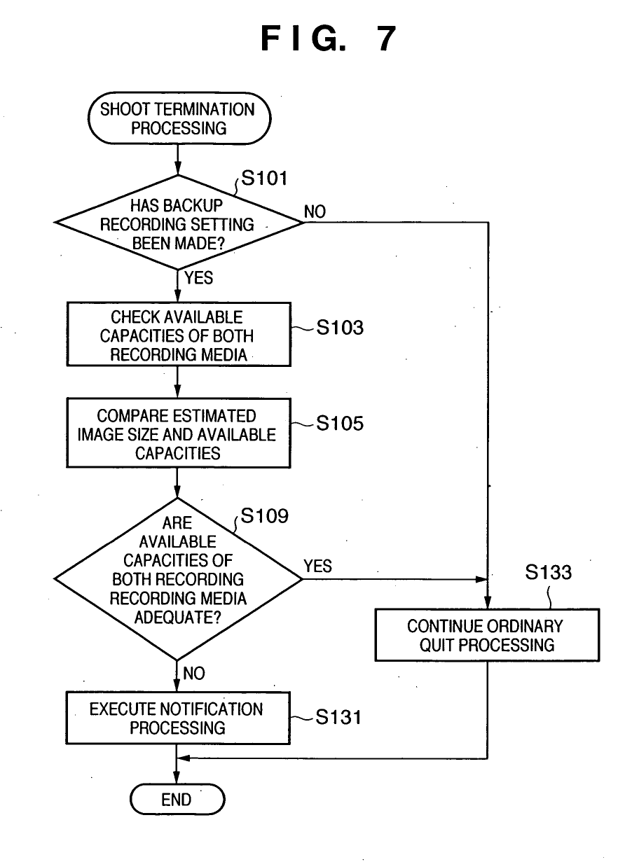

Processing at end of operation of the digital still camera according to this embodiment will be described with reference to the flowchart shown in FIG. 7. Steps in FIG. 7 for which the processing is identical with that of FIG. 5 are identified by like step numbers and need not be described again. Further, since the structure of the digital still camera according to this embodiment is identical with that shown in FIG. 4, the components thereof also need not be described again.

The processing illustrated in FIG. 7 is executed whenever the shooting of one image ends, by way of example. The processing of steps S101 to S109 in this embodiment is identical with that of the third embodiment with the exception of the processing in step S107. If it is determined in step S109 that the available capacity of either the normal recording medium or backup recording medium is inadequate, then, in step S131, the user is notified of the fact that backup recording cannot be performed the next time an image is captured, together with information (e.g., a slot number) that is capable of identifying the recording medium having the inadequate available capacity. The method of notifying the user can be implemented in a manner similar to that in which the prohibition on shooting is reported in step S115 in the first or fourth embodiment.

If it is determined in step S101 that backup recording has not been set, or if it is determined in step S109 that there is no recording medium of inadequate available capacity, then ordinary processing for quitting shooting is continued (step S133).

It is possible in step S131 to prohibit shooting, in a manner as performed in the third embodiment, and not merely provide notification to the user. Further, shooting may be prohibited only in a case where the setting giving priority to shooting has not been made, as described in the fourth embodiment.

In accordance with this embodiment, available capacities of the recording media are checked at the end of shoot processing. As a result, even in a case where backup recording is performed using multiple recording media having different available capacities, backup recording the next time an image is captured can be performed reliably. This embodiment naturally can be implemented in combination with the first or fourth embodiment.

### Other Embodiments

The first and fourth embodiments have been described with regard to an arrangement in which the available capacities of both recording media are checked only in a case where backup recording has been set. However, it may be so arranged that the processing of step S101 is deleted and whether the available capacities of both recording media are adequate is checked unconditionally.

In the above embodiments, the normal recording medium and the backup recording medium are both recording media that are removable. However, it should readily be understood that the present invention is applicable similarly also to an image sensing apparatus in which at least one of the media is built in. Further, the recording media may be in the form of a tape or disk. In the case of a recording medium in tape form, it will suffice to convert remaining time to available capacity. Further, at least one recording medium may be recordably connected by wired or wireless communication rather than being connected to the image sensing apparatus directly.

It should be noted that the present invention also covers a case where software programs for implementing the functions of the above embodiments are supplied directly from a recording medium, or through use of wired/wireless communication, to a system or apparatus having a computer that is capable of executing the above mentioned programs, and the system or apparatus executes the supplied programs to thereby implement the equivalent functions.

Accordingly, program code per se supplied to and installed in a computer in order that the computer may execute the processing of the present invention also implements the invention. In other words, the computer program that implements the processing of the present invention also is covered by the present invention.

In this case, so long as the system or apparatus has the functions of the program, the form of the program, e.g., object code, a program executed by an interpreter or script data supplied to an operating system, etc., does not matter.

Examples of recording media by which the program can be supplied are magnetic recording media such as floppy disk, hard disk and magnetic tape, optical/magneto-optical storage media such as a magneto-optical disk, CD-ROM, CD-R, CD-RW, DVD-ROM, DVD-R and DVD-RW, and a non-volatile semiconductor memory.

As for the method of supplying the program using wired/wireless communication, the computer program itself for forming the present invention in the server of a computer network, or a data file (program data file) that can serve as a computer program for forming the present invention in a client computer, such as a compressed file having an automatic install function, can be stored and the program data file can be downloaded to a connected client computer. In such case the program data file can be divided into a plurality of segment files and the segment files can be deployed at different servers.

In other words, the present invention also covers a server apparatus that allows multiple users to download a program data file for the purpose of implementing the functions of the present invention by computer.

Further, it is also possible to encrypt and store the program of the present invention on a storage medium such as a CD-ROM, distribute the storage medium to users, allow users who meet certain requirements to download decryption key information from, e.g., a website via the Internet, and allow these users to run the encrypted program by using the key information, whereby the program is installed in the user computer.

Furthermore, besides the case where the aforesaid functions according to the embodiments are implemented by executing the read program by computer, an operating system or the like running on the computer can perform all or a part of the actual processing based upon commands in the program so that the functions of the foregoing embodiments are be implemented by this processing.

Furthermore, after the program read from a recording medium is written to a function expansion board inserted into the computer or to a memory provided in a function expansion unit connected to the computer, a CPU or the like mounted on the function expansion board or function expansion unit can perform all or a part of the actual processing based upon commands in the program so that the functions of the foregoing embodiments can be implemented by this processing.

As many apparently widely different embodiments of the present invention can be made without departing from the spirit and scope thereof, it is to be understood that the invention is not limited to the specific embodiments thereof except as defined in the appended claims.

### CLAIM OF PRIORITY

This application claims priority from Japanese Patent Application No. 2004-032736 filed on Feb. 9, 2004, No. 2004-175999 filed on Jun. 14, 2004, and No. 2005-018255 filed on Jan. 26, 2005, which are hereby incorporated by reference herein.

1. An image sensing apparatus comprising:
a calculating unit adapted to calculate number of images that can be captured when image data representing captured images is recorded on first and second recording media,
wherein the calculating unit calculates number of images that can be captured in accordance with available capacity of the first recording medium in a case where available capacity of the first recording medium is less than available capacity of the second recording medium, and
wherein the calculating unit calculates number of images that can be captured in accordance with available capacity of the second recording medium in a case where available capacity of the second recording medium is less than available capacity of the first recording medium.

2. The apparatus according to claim 1, wherein the calculating unit calculates the number of images that can be captured by taking shooting conditions into consideration.

3. The apparatus according to claim 1, wherein capturing of images is prohibited if the number of images that can be captured calculated by the calculating unit is zero.

4. The apparatus according to claim 1, wherein image data representing a captured image is made recordable on either the first or second recording medium if the number of images that can be captured calculated by the calculating unit is zero.

5. The apparatus according to claim 1, wherein if the number of images that can be captured calculated by the calculating unit is zero when the available capacity of the first recording medium is less than the available capacity of the second recording medium, then image data representing a captured image is made recordable on the second recording medium; and
if the number of images that can be captured calculated by the calculating unit is zero when the available capacity of the second recording medium is less than the available capacity of the first recording medium, then image data representing a captured image is made recordable on the first recording medium.

6. A control method of an image sensing apparatus for calculating number of images that can be captured when image data representing captured images is recorded on first and second recording media, comprising:
a first calculating step of calculating number of images that can be captured in accordance with available capacity of the first recording medium in a case where available capacity of the first recording medium is less than available capacity of the second recording medium, and
a second calculating step of calculating number of images that can be captured in accordance with available capacity of the second recording medium in a case where available capacity of the second recording medium is less than available capacity of the first recording medium.

7. The method according to claim 6, wherein the first and second calculating steps calculate the number of images that can be captured by taking shooting conditions into consideration.

8. The method according to claim 6, wherein capturing of images is prohibited if the number of images that can be captured calculated by the first or second calculating step is zero.

9. The method according to claim 6, wherein image data representing a captured image is made recordable on either the first or second recording medium if the number of images that can be captured calculated by the first or second calculating step is zero.

10. The method according to claim 6, wherein if the number of images that can be captured calculated by the first calculating step is zero when the available capacity of the first recording medium is less than the available capacity of the second recording medium, then image data representing a captured image is made recordable on the second recording medium; and
if the number of images that can be captured calculated by the second calculating step is zero when the available capacity of the second recording medium is less than the available capacity of the first recording medium, then image data representing a captured image is made recordable on the first recording medium.
